(19) United States
(12) Patent Application Publication
(10) Pub. No.: US 2013/0031592 A1
(43) Pub. Date: Jan. 31, 2013

(54) SMART SET-TOP BOX AND OPERATION METHOD FOR SMART SERVICE AND DIGITAL TELEVISION SERVICE USING SINGLE OPERATING SYSTEM

(71) Applicants: Su Kyoung CHOI, Bucheon-si (KR); Gun Ho HONG, Seoul (KR); Won Ey LEE, Anyang-si (KR); Min Wook PARK, Seoul (KR); Dae Seok RYU, Yongin-si (KR); Jin Young SHIN, Namyangji-si (KR)

(72) Inventors: Su Kyoung CHOI, Bucheon-si (KR); Gun Ho HONG, Seoul (KR); Won Ey LEE, Anyang-si (KR); Min Wook PARK, Seoul (KR); Dae Seok RYU, Yongin-si (KR); Jin Young SHIN, Namyangji-si (KR)

(73) Assignee: LG CNS CO., LTD, Seoul (KR)

(21) Appl. No.: 13/359,541

(22) Filed: Jan. 27, 2012

(30) Foreign Application Priority Data
Jan. 27, 2011 (KR) 10-2011-0008397
Aug. 25, 2011 (KR) 10-2011-0085177

(51) Int. Cl. H04N 21/643

(52) U.S. Cl. 725/110

(57) ABSTRACT

A smart set-top box (STB) that provides a smart service and a digital television (DTV) service using a single operating system may be provided. The STB may load applications designed based on an application programming interface (API) of a framework corresponding to the operating system, may load a DTV stack including a DTV service function and a security service function, and may allow communication between at least one of the applications and the DTV stack when the at least one of the applications uses a binder driver included in a kernel of the operating system so as to access the DTV service function included in the DTV stack.

### CROSS-REFERENCE TO RELATED APPLICATION(S)

This application claims the benefit of Korean Patent Application Nos. 10-2011-0008397, 10-2011-0085177, filed on Jan. 27, 2011 and Aug. 25, 2011, respectively, filed in the Korean Intellectual Property Office, the disclosures of which are incorporated herein by reference.

### BACKGROUND

1. Field of the Invention

The present invention relates to a smart set-top box (STB) and an operating method thereof, and more particularly, to a method of providing a smart service and a digital television (DTV) service.

2. Description of the Related Art

A set-top box (STB) is a device that receives a signal from an external side via an Ethernet cable, a receiving antenna for a satellite wave or a ground wave, a coaxial cable, a telephone line, a VHF/UHF antenna, and the like, and appropriately converts the received signal so as to display corresponding contents on a television (TV) through a connection with the TV. Here, the STB may be included in the TV or may be a separate device.

A digital TV (DTV) service may be a service providing users with broadcast contents having a high definition and a high quality audio, using a broadcast signal compressed into a digital form. A smart service may be a service that enables downloading of varied applications from an application market and executing of the downloaded applications.

Recently, the smart service may be provided through smart phones, tablet personal computers (PC), and the like, in various forms, and the smart service may also be provided via TVs. In this example, a technology that controls a smart service and a DTV service provided via the TV using a single operating system may be required.

Most java applications for interactive TVs may be implemented based on the open cable application platform (OCAP), the advanced common application (ACAP), the multi-media home platform (MHP), and the globally executable MHP (GEM). However, a basic knowledge for a digital service may be required to implement the java applications for interactive TVs in an environment including a great number of application program interfaces (APIs). Therefore, most java applications for interactive TVs have not been commonly utilized. Conventionally, the number of Android-platform-based applications has dramatically increased, and knowledge for the Android platform may be readily obtainable. Accordingly, there are many attempts to provide a digital broadcasting terminal device based on an Android-platform.

### SUMMARY

An aspect of the present invention provides a method and apparatus that may provide a digital television (DTV) service and a smart service using a single device.

Another aspect of the present invention also provides a method and apparatus that may enable a developer to readily develop a TV application merely using application programming interfaces (APIs) contained, in advance, in an open platform, for example, an Android platform.

Still another aspect of the present invention also provides a method and apparatus that may be readily embodied without knowledge associated with the interactive TV standards, for example, the open cable application platform (OCAP), the multi-media home platform (MHP), and the like.

Yet another aspect of the present invention also provides a method and apparatus that may enable a DTV stack and an Android platform to be independent of each other, so as to support a quick upgrading of a platform.

According to an aspect of the present invention, there is provided a method of operating a smart set-top box (STB) that provides a smart service and a DTV service using a single operating system, the method including driving an operating system including at least a plurality of libraries and a kernel including a binder driver and drivers for a plurality of hardware devices, loading, in the operating system, applications designed based on an application programming interface (API) of a framework corresponding to the operating system, loading, in the operating system, a DTV stack including a DTV service function and a security service function, and allowing communication between at least one of the applications and the DTV stack when the at least one of the applications uses the binder driver included in the kernel of the operating system to access the DTV service function included in the DTV stack.

The operating system may correspond to an Android operating system.

The allowing may include encapsulating transmitted or received data in a parcel class.

The method may further include utilizing a DTV hardware abstraction layer (DTV HAL) for communication between the DTV service function and the security service function included in the DTV stack.

The binder driver may perform an inter-process communication (IPC) mechanism.

The method may further include accessing an application market through a network, and downloading at least one application from the application market based on selection by a user.

The DTV HAL may allow the communication between the DTV service function and the security service function using a library for hardware devices, a library for non-hardware devices, and a library for the DTV stack.

The library for hardware devices may process an access to hardware devices included in the smart STB, the library for non-hardware devices may be distinguished from the library for hardware devices, and may include modules associated with the DTV HAL, and the library for the DTV stack may include modules supporting the DTV service.

According to another aspect of the present invention, there is provided a method of embodying a platform that provides a smart service and a DTV service using a single operating system, the method including disposing, on a first layer, the operating system including at least a plurality of libraries and a kernel including a binder driver and drivers for a plurality of hardware devices, disposing, on a second layer that is an upper layer of the first layer, applications designed based on an API of a framework corresponding to the operating system, disposing, on a third layer that is an upper layer of the first layer and is a layer equivalent to the second layer, a DTV stack including a DTV service function and a security service function. Here, communication between at least one of the applications and the DTV stack may be performed when the at least one of applications uses the binder driver included in the kernel of the operating system so as to access the DTV service function included in the DTV stack.

According to still another aspect of the present invention, there is provided a smart STB, including a memory, a processor, and a plurality of hardware devices, providing a smart service and a DTV service in a single operating system, the smart STB including the processor to drive an operating system including at least a plurality of libraries and a kernel including a binder driver and drivers for the plurality of hardware devices, and the memory to load, in the operating system, applications designed based on an API of a framework corresponding to the operating system, and a DTV stack including a DTV service function and a security service function, and the processor may allow communication between at least one of the applications and the DTV stack when the at least one of the applications uses the binder driver included in the kernel of the operating system to access the DTV service function included in the DTV stack.

The memory may store libraries of the DTV HAL in a location referred to by a framework corresponding to the operating system.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a smart set-top box (STB) providing a digital television (DTV) service along with a smart service according to an embodiment of the present invention;

FIG. 2 is a block diagram illustrating a smart STB according to an embodiment of the present invention;

FIG. 3 is a diagram illustrating a configuration of a system including a well-known Android operating system;

FIG. 4 is a diagram illustrating an architecture of an Android DTV hardware abstraction layer (DTV HAL) according to an embodiment of the present invention;

FIG. 5 is a flowchart illustrating a method of providing both a DTV service and a smart service according to an embodiment of the present invention; and

FIG. 6 is a block diagram illustrating a smart STB according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

A digital television (DTV) service may be a service providing broadcast contents having a high-definition and a high quality audio using a broadcast signal compressed into a digital form, which is different from a conventional analog service. The DTV service may provide a greater amount of information using digital signals, when compared to the analog service and thus, may provide a data service. According to the DTV service, users may be provided with an electronic program guide (EPG) service that informs the users of a TV program broadcasting time, information associated with cast members, and the like, and a video on demand (VOD) service that enables the users to select and view a desired program at a desired time. To provide the DTV service, a set-top box (STB) that restores the broadcast signal compressed into a digital form to an original image and an original audio signal may be required.

A smart service may be a service that enables downloading of varied applications from an application market, for example, App Store, Android Market, Blackberry App World, and the like, and enables executing of the downloaded applications. The applications may refer to various programs executed based on an operating system. Examples of the application may include an Internet browser, Google map, You Tube, widgets, and the like, and there may be varied types of application. App Store is the Apple online application market from which iOS applications may be downloaded with and/or without fee. Android Market is the online application market, managed by Google, for Android applications. A platform for the smart service may be, for example, an Android-based open platform.

Embodiments of the present invention may provide a smart STB that is able to provide a DTV service and a smart service in a single operating system. That is, a user may be able to use both the DTV service and the smart service in a single operating system using a single device, for example, the smart STB.

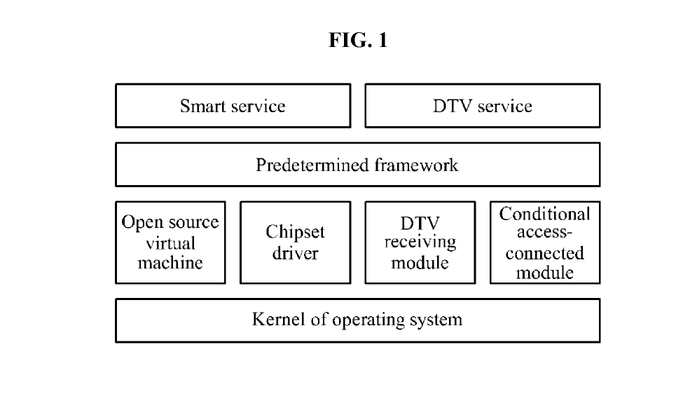

FIG. 1 illustrates a configuration of a smart STB providing a DTV service along with a smart service according to an embodiment of the present invention.

The smart STB may have varied hardware configurations and varied software configurations. FIG. 1 shows the configuration of the smart STB that provides both the DTV service and the smart service.

The smart STB may include an Android operating system, and may utilize various operating systems. For example, an Android operating system-based Linux kernel may be included. The smart STB may include an open source virtual machine, a chipset driver, a DTV receiving module, and a conditional access-connected module. The smart service and the DTV service may be provided based on a framework corresponding to an operating system, for example, a well-known Android framework.

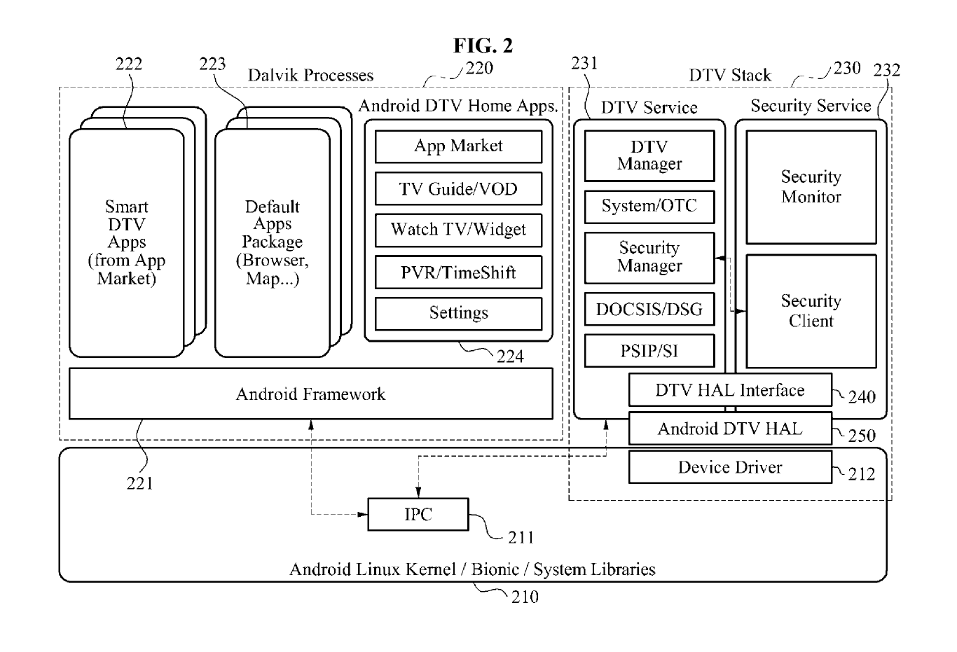

FIG. 2 illustrates a smart STB according to an embodiment of the present invention.

Referring to FIG. 2, the smart STB may operate based on an Android operating system 210.

The Android operating system 210 of FIG. 2, disposed on a first layer, may include a Linux kernel, Bionic, system libraries, and a binder driver for an inter-process communication (IPC) 211. Here, both a DTV service and a smart service may be provided based on the single Android operating system 210. In this example, the Android operating system 210 may operate based on varied versions of Linux kernel, for example, a Linux kernel 2.6.

The Linux kernel may operate first through a boot-loader when the smart STB is booted up, and the Android operating system 210 may perform an ‘init’ process that initializes a system after initializing a kernel.

The Android operating system 210 may include Bionic, that is, the C standard library (Libc). Bionic is a C library that is obtained by amending a Berkeley software distribution (BSD)-based libc to be suitable for a mobile environment, that is, an embedded environment, and may support services specified for Android. All native codes operating in the Android operating system 210 may be compiled using Bionic.

The Android operating system 210 may include a binder driver that performs an Android IPC mechanism. The IPC mechanism may refer to exchanging of data among processes. The Android operating system 210 may perform communication among processes of the Android operating system 210, for example, playback of a video, playback of an audio, a camera, management of activities, and the like, using the binder driver.

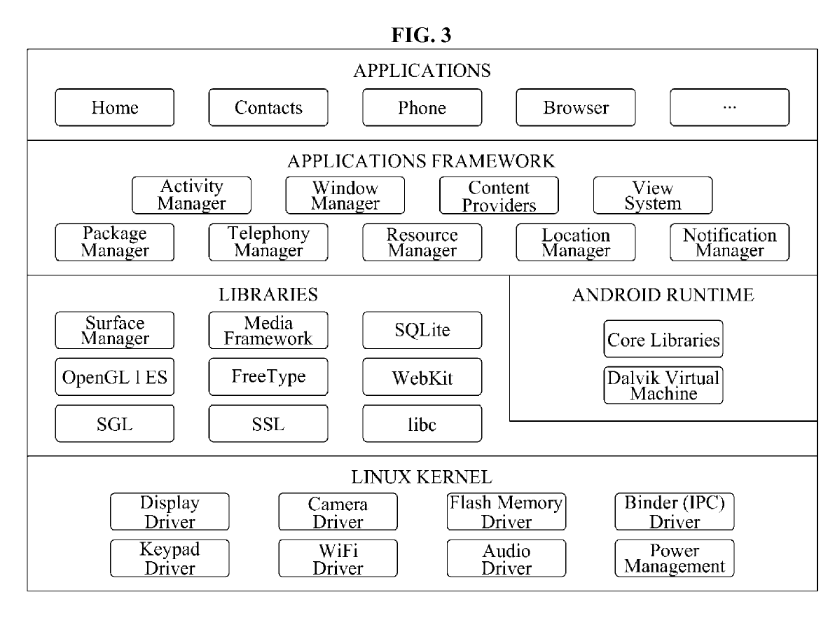

The Android operating system 210 will be described with reference to FIG. 3. The Linux kernel manages a plurality of hardware devices, an internal memory, a processor, a networking, and the like, and the system libraries may be configured to include a Dalvik virtual machine (DVM) and libraries to be used for utilizing a plurality of hardware devices to play back a graphic, a moving picture, and the like.

A security service module 232 included in a DTV stack 230, disposed on an upper layer of the first layer, may control a conditional-access of a user, in the Android operating system 210. For example, the security service module 232 may be embodied by eXchangeable Conditional Access System Secure Micro (XCAS SM).

The security service module 232 for the security service may include a security monitor, for example, an exchangeable conditional access system (XCAS) monitor, and a security client, for example, a conditional access system (CAS) client. The security service module 232 for the security service may provide a platform for executing the security client, for example, installing and updating of the security client, and providing of a security function.

The DTV stack 230 may provide the user with a DTV service included in the DTV stack 230 that provides a DTV service, in the Android operating system 210 based on qualification of the user. In particular, the DTV stack 230 may insert a portion of a conventional STB that provides a DTV service, into an Android platform. The DTV stack 230 may provide a function of parsing and caching a DTV service broadcast information table, a function of connecting data over cable service interface specification (DOCSIS) set-top gate way (DSG), a function of connecting interactive communication, for example, a cable modem or a local area network (LAN), a security function, for example, XCAS, a function of upgrading a system, and the like. To support the functions, a DTV service block 231 may include a DTV manager block, a system/OTC block, a security manager block, a DOCSIS/DSG block, a program specific information protocol/service information (PSIP/SI) block, and the like.

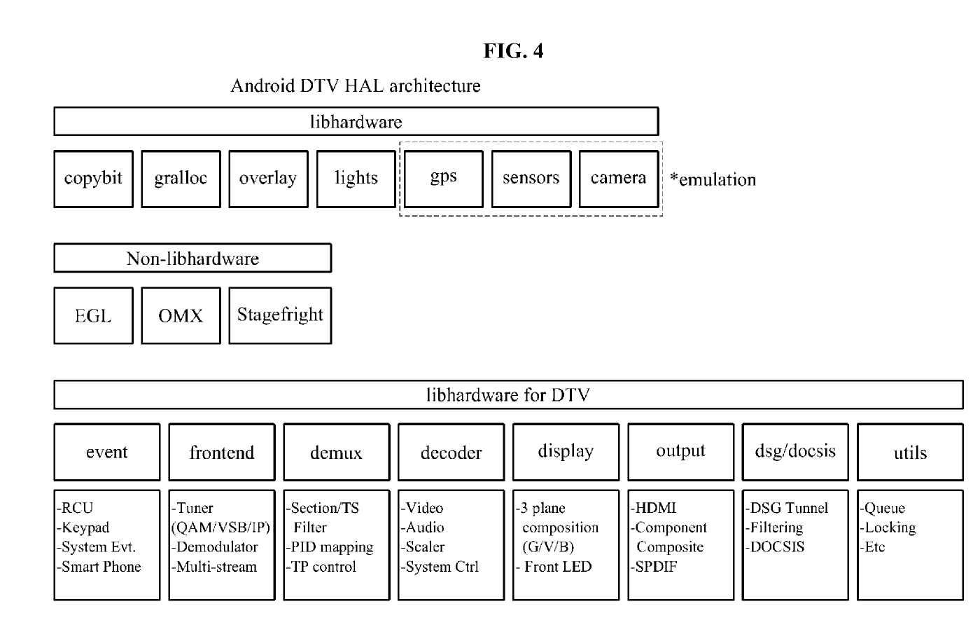

A hardware abstraction layer (HAL) 250 may allow the Android operating system 210 to communicate with the DTV stack 230 based on Android. Here, the DTV HAL 250 may be obtained by abstraction of an interface of a device driver 212. An example of the device driver 212 may include the Trident device driver. The configuration of the DTV HAL 250 will be described with reference to FIG. 4.

The Android framework 221 may include an application programming interface (API) for applications. The Android operating system 211 may execute and/or load varied applications 222 and 223 using the Android framework 221.

The user may play back, through a DTV, an image associated with an Android application using the Android framework 221 through a Java TV/home audio video interoperability (HAVi)/open cable application platform (OCAP) subset. That is, the Android framework 221 may provide DTV broadcast contents to the DVM on which the Android application operates.

The Java TV/HAVi/OCAP subset may be middleware for providing the DTV service. In particular, a Java TV may be a Java-based software framework for providing the DTV service, and may be an interface for a developer who develops software operating in an interactive TV service and a digital broadcast receiver. The HAVi may be middleware supporting data communication and the controlling of sound and imaging devices. The OCAP may be middleware for broadcasting data of an interactive host defined by CableLabs. The Java TV/HAVi/OCAP subset may include a few APIs of the Java TV, the HAVi, and the OCAP for supporting the DTV service and the Android application.

The smart STB may include the Android applications 222 and 223 implemented in the Android operating system 211. Here, the Android applications may include the basic applications 223, for example, Internet browse, a map, and the like, and applications 222 downloaded from an application market.

The application 222 may be a fused application of DTV broadcast contents and an Android application. Accordingly, the user may use varied Android applications along with DTV broadcast contents associated with corresponding applications, through the smart STB. The user may execute an Android application while receiving the DTV service through the smart STB.

The smart STB may download applications associated with a DTV service from an application market including a plurality of applications associated with the DTV service, based on selection of the user. Also, the smart STB may be able to download varied Android applications that are not associated with the DTV service.

A home screen of an Android DTV of the smart STB may include varied menus, for example, an ‘Application Market’ menu, a ‘TV guide’ menu, a ‘VOD’ menu, a ‘view TV’ menu, a ‘Widget’ menu, a ‘personal video recorder (PVR)’ menu, a ‘Time Shift’ menu, a ‘Settings’ menu, and the like.

For example, when the user selects the ‘Application Market’ menu, the smart STB may access an application market, and may download varied applications based on the selection of the user. When the user selects one of applications stored in the smart STB, the smart STB may execute the corresponding application.

The method of providing the smart service and the DTV service using the single Android operating system 210 has been described. The Android framework 221 may be allowed to communicate with the DTV service (block) 231 included in the DTV stack 230, through the binder driver that uses the IPC mechanism. That is, the embodiments of the present invention may provide the DTV service and the smart service in a single operating system, using the binder driver included in the operating system 210.

In this example, data exchanged during the communication between the Android framework 221 and the DTV service (block) 231 included in the DTV stack 230 may be encapsulated in a class for transmission and reception. In addition, a security manager of the DTV service (block) 231 and a security client of the security service (module) 232 may perform transmission and reception of data based on a socket communication scheme, and the security client may be embodied to be compatible with another CAS. Also, the DTV service (block) 231 and the security service (module) 232 may be embodied to operate irrespective of a specification of hardware and a type of hardware.

FIG. 3 illustrates a configuration of a system including a well-known Android operating system.

Referring to FIG. 3, the Android operating system may be configured to include four layers. A Linux kernel 310 may manage networking in addition to managing of hardware devices, an internal memory, and processes. A library layer 320 based on C/C++may be configured to include Dalvik VM and a library for a plurality of hardware devices for playback of a graphic, a moving picture, and the like. An Android framework or an application framework 330 may provide a java API to be used for generating an application. An application layer 340 may be a most upper layer in which applications developed by developers using an API of the application framework 330 are distributed and executed. An Android platform may be an open platform in which sources of all layers are opened, and may be mainly utilized for a smartphone.

As described in the foregoing, embodiments of the present invention may provide a unique platform for providing the smart service and the DTV service in the Android operating system.

FIG. 4 illustrates an architecture of an Android DTV HAL according to an embodiment of the present invention.

Referring to FIG. 4, the architecture of the Android DTV HAL may provide a DTV stack that is based on an Android operating system and that includes a DTV service and a security service, and may provide libraries for communication with the Android operating system, that is, a libhardware 410, a non-libhardware 420, and libhardware for DTV 430. In particular, the architecture of the Android DTV HAL may include the libhardware 410 corresponding to a library for hardware devices, the non-libhardware 420 corresponding to a library for non-hardware devices, and the libhardware for DTV 430 corresponding to a library for the DTV stack.

The libhardware 410 may be used for accessing a hardware device included in a smart STB of an Android system. The libhardware 410 may include a module associated with a graphic, a sensor, a global positioning system (GPS), a camera, or the like.

The non-libhardware 420 may include a module associated with the Android DTV HAL among modules that are excluded from the libhardware 410. For example, the non-libhardware 420 may include multi-media frameworks, such as, the electronic guarantee letter (EGL) framework, the OPenMAX (OMX) framework, the stagefright framework. In particular, the EGL may be a native platform interface, and may define a glue interface layer function between a predetermined platform system and an OpenGL ES API. The OMX framework may be the standard API media interface of Khronos Group, and the stagefright framework may be a media framework created by Google.

The libhardware for DTV 430 may include modules added for the DTV service, excluding the module included in the libhardware 410. The libhardware for DTV 430 may provide varied functions, for example, tuning of a DTV, zapping of a DTV, and the like, based on each module included in the libhardware for DTV 430. Each module included in the libhardware for DTV 430 of FIG. 4 may exist in a form of a library, and libraries of a DTV HAL may be stored in a location referred to by the Android framework so as to reuse the libraries used by the DTV stack. Accordingly, a Android application service utilizes the libraries.

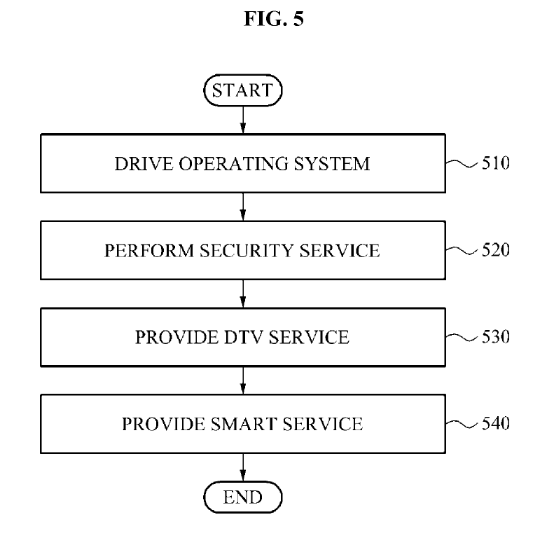

FIG. 5 illustrates a method of providing both a DTV service and a smart service according to an embodiment of the present invention.

Referring to FIG. 5, a smart STB may drive an operating system that includes at least a plurality of libraries and a kernel including a binder driver and drivers for a plurality of hardware devices in operation 510.

The smart STB may load a DTV stack including a DTV service function and a security service function in the operating system, and may execute a security service in operation 520. Accordingly, a conditional-access of a user may be controlled.

The smart STB may provide the user with a DTV service through the DTV stack that provides a DTV service in an Android operating system based on a qualification of the user in operation 530.

The smart STB may load applications designed based on an API of a framework corresponding to the operating system, in the operating system, and may execute at least one application so as to provide the user with a smart service in operation 540.

Although it is not explicitly illustrated in FIG. 5, embodiments of the present invention may allow communication between at least one of the applications and the DTV stack when the at least one of the application uses the binder driver included in the kernel of the operating system to access the DTV service function included in the DTV stack. In this example, a DTV HAL may be utilized to perform communication between the DTV service function and the security service function included in the DTV stack.

A method of operating the smart STB has been described. The embodiments described in the foregoing with respect to FIGS. 1 through 4 may be applicable to the method of operating the smart STB and thus, detailed descriptions thereof will be omitted.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

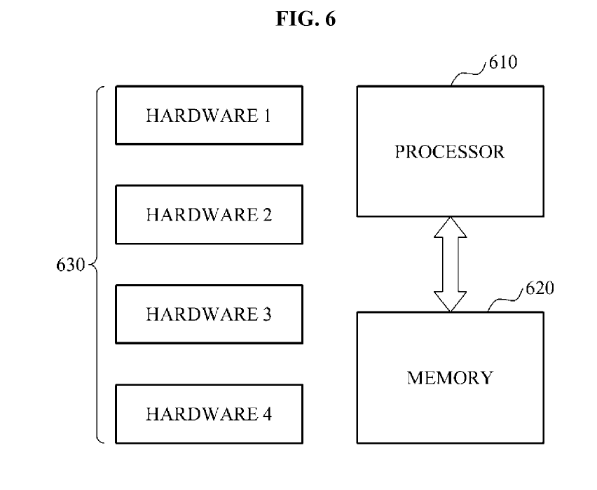

FIG. 6 illustrates a smart STB according to an embodiment of the present invention.

Referring to FIG. 6, the smart STB may include a processor 610, a memory 620, and a plurality of hardware devices 630. Here, the plurality of hardware devices 630 may include varied devices, for example, a keyboard, a tuner, a decoder, a modulator, network devices, sensors, and the like.

The processor 610 may drive an operating system including at least a plurality of libraries and a kernel including a binder driver and drivers for the plurality of hardware devices 630. In this example, in the operating system, applications designed based on an API of a framework corresponding to the operating system and a DTV stack including a DTV service function and a security service function may be loaded into the memory 620.

In this example, the processor 610 may allow communication between at least one of the applications and the DTV stack when the at least one of the applications uses the binder driver included in the kernel of the operating system to access the DTV service function included in the DTV stack. Accordingly, a smart service and the DTV service may be provided in a single operating system.

The embodiments described in the foregoing with reference to FIGS. 1 through 5 may be applicable to the smart STB of FIG. 6 and thus, detailed descriptions thereof will be omitted.

The embodiments of the present invention may provide a method and apparatus that may provide a DTV service and a smart service using a single device.

The embodiments of the present invention may provide a method and apparatus that may enable a developer to readily develop a TV application merely using

APIs contained, in advance, to an open platform such as an Android platform.

The embodiments of the present invention may provide a method and apparatus that may be readily embodied without knowledge associated with an interactive TV standard, for example, OCAP, MHP, and the like.

The embodiments of the present invention may provide a method and apparatus that may enable a DTV stack and an Android platform to be independent of each other so as to support a quick upgrading of a platform.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of operating a smart set-top box (STB) that provides a smart service and a digital television (DTV) service using a single operating system, the method comprising:
driving an operating system comprising at least a plurality of libraries and a kernel including a binder driver and drivers for a plurality of hardware devices;
loading, in the operating system, applications designed based on an application programming interface (API) of a framework corresponding to the operating system;
loading, in the operating system, a DTV stack including a DTV service function and a security service function; and
allowing communication between at least one of the applications and the DTV stack when the at least one of the applications uses the binder driver included in the kernel of the operating system to access the DTV service function included in the DTV stack.

2. The method of claim 1, wherein the operating system corresponds to an Android operating system.

3. The method of claim 1, wherein the allowing comprises:
encapsulating transmitted or received data in a parcel class.

4. The method of claim 1, further comprising:
utilizing a DTV hardware abstraction layer (DTV HAL) for communication between the DTV service function and the security service function included in the DTV stack.

5. The method of claim 4, wherein the DTV HAL allows the communication between the DTV service function and the security service function using a library for hardware devices, a library for non-hardware devices, and a library for the DTV stack.

6. The method of claim 5, wherein:
the library for hardware devices processes an access to hardware devices included in the smart STB;
the library for non-hardware devices is distinguished from the library for hardware devices, and includes modules associated with the DTV HAL; and
the library for the DTV stack includes modules supporting the DTV service.

7. The method of claim 1, wherein the binder driver performs an inter-process communication (IPC) mechanism.

8. The method of claim 1, further comprising:
accessing an application market through a network; and
downloading at least one application from the application market based on selection by a user.

9. The method of claim 1, wherein:
the DTV stack supports an electronic program guide (EPG) service or a video-on-demand (VOD) service; and
the applications are downloaded through the smart service.

10. A non-transitory computer-readable medium comprising a program for instructing a computer to perform the method of claim 1.

11. A smart set-top box (STB), comprising a memory, a processor, and a plurality of hardware devices, providing a smart service and a digital television (DTV) service in a single operating system, the smart STB comprising:
the processor to drive an operating system comprising at least a plurality of libraries and a kernel including a binder driver and drivers for the plurality of hardware devices; and
the memory to load, in the operating system, applications designed based on an application programming interface (API) of a framework corresponding to the operating system, and a DTV stack including a DTV service function and a security service function,
wherein the processor allows communication between at least one of the applications and the DTV stack when the at least one of the applications uses the binder driver included in the kernel of the operating system to access the DTV service function included in the DTV stack.

12. The smart STB of claim 11, wherein:
the operating system is disposed on a first layer;
the applications designed based on the API of the framework corresponding to the operating system are disposed on a second layer that is an upper layer of the first layer; and
the DTV stack including the DTV service function and the security service function is disposed on a third layer, which is an upper layer of the first layer and is a layer equivalent to the second layer.

13. The smart STB of claim 11, wherein the operating system corresponds to an Android operating system.

14. The smart STB of claim 11, wherein the binder driver performs inter-process communication (IPC) mechanism.

15. The smart STB of claim 11, wherein the processor uses a DTV hardware abstraction layer (DTV HAL) for communication between the DTV service function and the security service function included in the DTV stack.

16. The smart STB of claim 15, wherein the memory stores libraries of the DTV HAL in a location referred to by a framework corresponding to the operating system.
